(19) United States
(12) Patent Application Publication
(10) Pub. No.: US 2026/0158518 A1
(43) Pub. Date: Jun. 11, 2026

(54) SLOT DIE COATER AND SLURRY COATING APPARATUS INCLUDING THE SAME

(71) Applicant: SAMSUNG SDI CO., LTD., Yongin-si (KR)

(72) Inventor: JISUN LEE, Yongin-si (KR)

(21) Appl. No.: 19/227,844

(22) Filed: Jun. 4, 2025

(30) Foreign Application Priority Data
Dec. 5, 2024 (KR) 10-2024-0179779

(51) Int. Cl. B05C 5/02; B05C 13/02; H01M 4/04

(52) U.S. Cl. CPC B05C 5/0254; B05C 13/02; H01M 4/0404; H01M 4/0411

(57) ABSTRACT

A slot die coater includes an intermediate block, a first block facing one side of the intermediate block, a second block facing an opposite side of the intermediate block, a first spacer between the first block and the intermediate block, the first spacer having a first discharge port, and a second spacer between the second block and the intermediate block, the second spacer having a second discharge port, wherein a pair of first inner surfaces on opposite sides of the first discharge port, respectively, have first protruding lines extending along a lengthwise direction of the first discharge port, each of the first protruding lines having a first height.

### CROSS-REFERENCE TO RELATED APPLICATION

This application is based on and claims priority under 35 U.S.C. §119 to Korean Patent Application No. 10-2024-0179779, filed on December 5, 2024, in the Korean Intellectual Property Office, the disclosure of which is incorporated by reference herein in its entirety.

### BACKGROUND

### Field

The present disclosure relates to a slot die coater and a slurry coating apparatus including the same.

### Description of the Related Art

In general, secondary batteries are batteries that may be charged and discharged unlike primary batteries that may not be charged. Low-capacity secondary batteries are used in small-sized electronic devices that are portable such as smartphones, feature phones, laptop computers, digital cameras, and camcorders, and large-capacity secondary batteries are widely used as power sources for driving motors in hybrid cars, electric vehicles, etc., and power storage batteries.

As demands for various electronic devices increase, demands for secondary batteries also increase, and the secondary battery includes an electrode assembly as an essential component. An electrode assembly has a form in which a positive electrode, a separator, and a negative electrode are stacked at least once, and the positive electrode and the negative electrode are manufactured by applying and drying a positive electrode active material slurry and a negative electrode active material slurry respectively on current collectors including an aluminum foil and a copper foil.

The above information disclosed in this background section is only for enhancement of understanding of the background of the disclosure and therefore it may contain information that does not form the related art that is already known to a person of ordinary skill in the art.

### SUMMARY

Embodiments include a slot die coater, including an intermediate block, a first block facing one side of the intermediate block, a second block facing an opposite side of the intermediate block, a first spacer between the first block and the intermediate block, the first spacer having a first discharge port, and a second spacer between the second block and the intermediate block, the second spacer having a second discharge port, wherein a pair of first inner surfaces on opposite sides of the first discharge port, respectively, have first protruding lines extending along a lengthwise direction of the first discharge port, each of the first protruding lines having a first height.

The pair of first inner surfaces may be parallel to each other.

A width of the first discharge port may be reduced outward in the lengthwise direction of the first discharge port.

Each of the pair of first inner surfaces may have a first outer inclined surface being inclined outward in the lengthwise direction of the first discharge port.

The pair of first inner surfaces and a pair of second inner surfaces in the second discharge port may be parallel to each other.

The first protruding lines may be on the pair of first inner surfaces of the first discharge port and adjacent to the intermediate block.

The first protruding lines may each have a first protrusion height less than a thickness value of the first spacer.

A first discharge width of the first discharge port may be less than or equal to a second discharge width of the second discharge port.

Second protruding lines each having a second height may be on second inner surfaces of the second discharge port along a lengthwise direction of the second discharge port.

A second protrusion height of the second protruding lines may be less than a first protrusion height of the first protruding lines.

Embodiments include a slurry coating apparatus, including a slurry tank accommodating slurry, a roller unit transporting a current collector on which the slurry is coated, and a slot die coater receiving a supply of slurry from the slurry tank and coating the current collector with the slurry, wherein the slot die coater includes an intermediate block, a first block facing the intermediate block on one side of the intermediate block, a second block facing the intermediate block on an opposite side of the intermediate block, a first spacer between the first block and the intermediate block, the first spacer having a first discharge port, and a second spacer between the second block and the intermediate block, the second spacer having a second discharge port, and a pair of first inner surfaces on opposite sides of the first discharge port, respectively, have first protruding lines, each of the first protruding lines having a first length in a lengthwise direction of the first discharge port.

The second block, the intermediate block, and the first block may be in a direction in which the current collector moves.

The pair of first inner surfaces may be parallel to each other.

A width of the first discharge port may be reduced outward in the lengthwise direction of the first discharge port.

Each of the pair of first inner surfaces may have first outer inclined surface having a width increased outward in the lengthwise direction of the first discharge port.

Each of the pair of first inner surfaces and a pair of second inner surfaces in the second discharge port may be parallel to each other.

The first protruding lines are on the first inner surfaces of the first discharge port, to be adjacent to the second block.

The first protruding lines may each have a first length value greater than a thickness of the first spacer.

A first discharge width of the first discharge port may be less than or equal to a second discharge width of the second discharge port.

Second protruding lines each having a second height may be on second inner surfaces of the second discharge port along a lengthwise direction of the second discharge port.

### BRIEF DESCRIPTION OF THE DRAWINGS

Features will become apparent to those of ordinary skill in the art by describing in detail exemplary embodiments with reference to the attached drawings, in which:

FIG. 1 is a diagram of a slurry coating apparatus according to an embodiment of the present disclosure;

FIG. 2 is a diagram showing a part of the slurry coating apparatus of FIG. 1 in detail;

FIG. 3 is an exploded perspective view of a slot die coater of FIG. 1;

FIG. 4 is a plan view showing a first spacer and a second spacer according to an embodiment of the present disclosure;

FIG. 5 is a front view of the first spacer and the second spacer of FIG. 4;

FIG. 6 is a diagram for describing a result of coating a slurry performed by a slot die coater including the first spacer and the second spacer of FIG. 4;

FIG. 7 is a front view showing a first spacer and a second spacer according to another embodiment of the present disclosure;

FIG. 8 is a diagram for describing a result of coating a slurry performed by a slot die coater including the first spacer and the second spacer of FIG. 7;

FIG. 9 is a front view showing a first spacer and a second spacer according to another embodiment of the present disclosure; and

FIG. 10 is a plan view showing a first spacer and a second spacer according to another embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

In addition, it will be further understood that the terms that the terms “comprise” or “include” and/or “comprising” or “including,” when used in this specification, specify the presence of stated features, numbers, steps, operations, elements, and/or components, but do not preclude the presence or addition of one or more other features, numbers, steps, operations, elements, components, and/or groups thereof.

The term equal refers to 'substantially equal'. Accordingly, substantially equal may include the deviation regarded as a low level in the corresponding technical field, for example, the deviation of 5% or less. In addition, a uniform parameter in a predetermined area may refer to uniform from the average point of view.

Expressions including ordinal numbers such as "first" and "second" indicate various elements, but the above expressions do not limit the elements. These terms are used to distinguish one element from another, and unless the context clearly indicates otherwise, a first element may be a second element.

As used herein, the singular forms are intended to include the plural forms as well, unless the context clearly indicates otherwise.

It will be understood that when an element is referred to being "on (or below)" or "above (or under)" another element, it may be positioned in contact with an upper surface (or a lower surface) of the other element, but another element may be positioned between the element and the other element on (or below) the element.

It will be further understood that when an element is referred to as being "connected", "coupled" or "joined" to another element, the elements may be directly connected or joined to each other, but intervening elements may be present between them or each element may be "connected", "coupled" or "joined" to each other through another element. It will be understood that when an element is referred to as being "electrically coupled" to another element, the element can be directly electrically coupled to another element or intervening elements may be present.

Throughout the specification, the terms "A and/or B" imply A, B, or A and B, unless otherwise defined. That is, the term "and/or" includes all or various combinations of a plurality of items that are related and arranged. The terms “C to D” imply C or more and D or less, unless otherwise described.

The terminology used herein is for the purpose of describing embodiments of the present disclosure and is not intended to be limiting of the present disclosure.

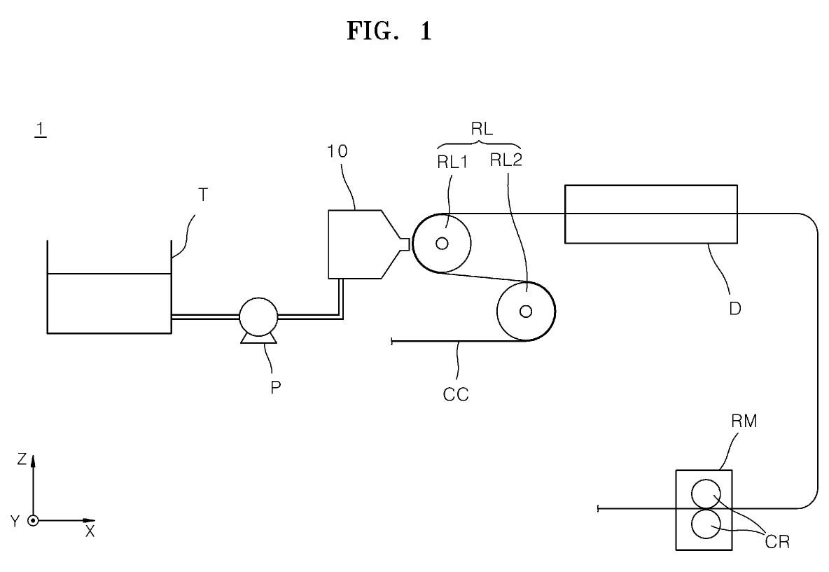

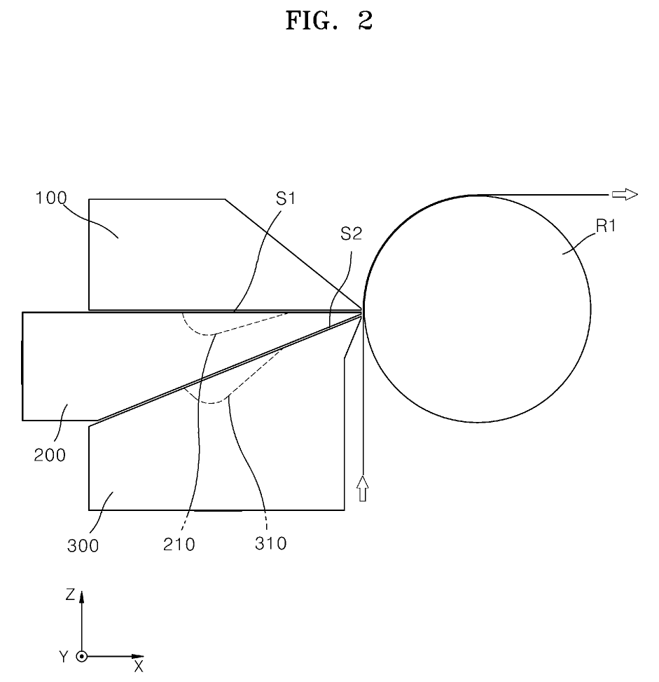

FIG. 1 is a diagram of a slurry coating apparatus according to an embodiment of the present disclosure. FIG. 2 is a diagram showing a part of the slurry coating apparatus of FIG. 1 in detail.

Referring to FIG. 1, the slurry coating apparatus according to an embodiment of the present disclosure may include a slurry tank T, a roller unit RL, a slot die coater 10, and a drying furnace D.

The slurry tank T may accommodate an active material slurry (hereinafter, 'slurry') therein. The slurry tank T spatially separates an inner space and an outer space so as to protect the slurry stored therein.

The slurry tank T may be connected to the slot die coater 10. The slurry tank T is fluidically connected to the slot die coater 10 and may transfer the stored slurry to the slot die coater 10.

A pump P may be arranged between the slurry tank T and the slot die coater 10. The pump P may be arranged on a line that fluidically connects the slurry tank T to the slot die coater 10.

The pump P may supply flow energy to the slurry stored in the slurry tank T. The pump P may withdraw the slurry stored in the slurry tank T and supply the slurry to the slot die coater 10.

The slurry may be coated on a current collector CC. The current collector CC may connect the slurry coated on the current collector CC to an electrical circuit.

The current collector CC may include a material having a high electrical conductivity. For example, the current collector CC may include copper or aluminum, but the material included in the current collector CC may vary.

The roller unit RL may guide the current collector CC toward a discharge port of the slot die coater 10. The roller unit RL may determine a moving passage of the current collector CC by contact-supporting the current collector CC. The roller unit RL may transport the current collector on which the slurry is coated along the moving passage by rotating while being in contact with the current collector CC.

In an embodiment, the roller unit RL may include a first roller RL1 and a second roller RL2.

Referring to FIG. 1 and FIG. 2, the first roller RL1 may be arranged adjacent to the slot die coater 10. The first roller RL1 may be arranged adjacent to the discharge port of the slot die coater 10 and determine the moving passage of the current collector CC (e.g., the slot die coater 10 may monitor the movement of the current collector CC) so that the current collector CC may have the moving passage adjacent to the discharge port side of the slot die coater 10.

Hereinafter, 'lower slurry' denotes the slurry coated on the current collector CC and 'upper slurry' is defined as the slurry coated on the lower slurry.

The first roller RL1 may be arranged adjacent to the discharge port side of the slot die coater 10 and then may be rotated. That is, the slurry discharged from the slot die coater 10 may be coated on the current collector that passes through between the first roller RL1 and the slot die coater 10.

For example, the first roller RL1 may rotate in a clockwise direction. The first roller RL1 may rotate the current collector CC so that the current collector CC may move in a direction from a lower portion toward an upper portion of the slot die coater 10 (Z-axis direction). As such, the slurry discharged from a second manifold 310 is coated first on the current collector CC passing between the slot die coater 10 and the first roller RL1, and then, the slurry discharged from a first manifold 210 may be coated on the coated slurry. That is, the slurry discharged from the second manifold 310 and coated on the current collector CC may be the lower slurry, and the slurry discharged from the first manifold 210 and coated on the current collector CC may be the upper slurry.

The second roller RL2 may be arranged to be spaced apart at a preset interval from the first roller RL1. For example, the second roller RL2 may be arranged to be spaced apart from the first roller RL1 in a direction opposite to the slot die coater 10.

The second roller RL2 may apply a tension to the current collector CC by pulling the current collector CC wound around the first roller RL1 toward the direction opposite to the slot die coater 10. That is, the second roller RL2 may evenly coat the slurry discharged from the slot die coater 10 on the current collector CC by pressing the current collector CC toward the first roller RL1.

The drying furnace D may include an inner space. For example, the drying furnace D has an inner space with opposite sides that are opened so as to provide a passage through which the current collector CC may pass in the inner space.

The drying furnace D may include a heating source for generating heat in the inner space. The drying furnace D may apply heat onto the slurry on the current collector passing through the inner space by using the heat generated by the heating source. Thus, the slurry on the current collector CC passing through the drying furnace D may be dried.

A rolling device RM may press the current collector CC having passed through the drying furnace D to be pressed and attached. The rolling device RM may include upper and lower rolls CR to press the current collector CC passing through the rolling device RM. Thus, the current collector CC is pressed and attached, and then, is cut to be manufactured as a positive electrode or a negative electrode of a battery.

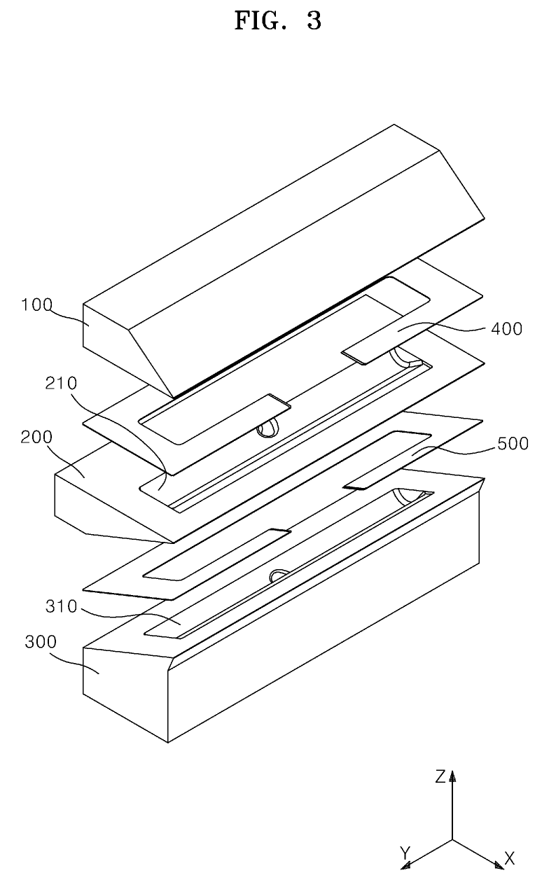

FIG. 3 is an exploded perspective view of the slot die coater of FIG. 1.

Referring to FIGS. 1, 2, and 3, the slot die coater 10 may coat the slurry on the current collector CC.

The slot die coater 10 is fluidically connected to the slurry tank T and may receive the supply of the slurry stored in the slurry tank T. The slot die coater 10 discharges the slurry supplied by the pump P toward the current collector CC so as to coat the slurry onto the current collector CC.

The slot die coater 10 may discharge the slurry through a plurality of passages. For example, the slot die coater 10 may discharge the slurry via two passages so that the current collector CC may be coated with two layers of slurry. In detail, the slot die coater 10 discharges the slurry via two passages so as to coat the lower slurry and the upper slurry on the current collector CC.

Referring to FIGS. 2 and 3, the slot die coater 10 may include a first block 100, an intermediate block 200, a second block 300, a first spacer 400, and a second spacer 500.

The first block 100, the intermediate block 200, and the second block 300 may form the slot die coater 10. For example, the first block 100 is arranged at one side of the intermediate block 200, and the second block 300 is arranged at the other side of the intermediate block 200 to form the slot die coater 10.

The first block 100, the intermediate block 200, and the second block 300 may be coupled via a bolt, for example, to form the slot die coater 10. However, the fastening method of the first block 100, the intermediate block 200, and the second block 300 may vary.

Referring to FIG. 2, the first block 100 and the intermediate block 200 may be spaced apart at a preset interval from each other. The first block 100 and the intermediate block 200 may provide a space, through which the slurry may move, via the spaced interval. In other words, the spaced interval between the first block 100 and the intermediate block 200 may provide a first slot S1. The slurry may be discharged out of the slot die coater 10 via the first slot S1.

The first block 100 and the intermediate block 200 may be arranged to face each other. For example, one surface of the first block 100 and one surface of the intermediate block 200 may be arranged parallel to each other. The first block 100 and the intermediate block 200 may be arranged so that one surface of the first block 100 and one surface of the intermediate block 200 are in parallel with each other. Thus, the first slot S1 may have a constant thickness in a direction in which the slurry is discharged (X-axis direction).

The intermediate block 200 may include the first manifold 210. The first manifold 210 may be a concave-shaped chamber formed in the intermediate block 200. The first manifold 210 may provide a space in which the slurry supplied from the outside may be temporarily stored.

The first manifold 210 may be connected to outside. The first manifold 210 may be in communication with the outside of the slot die coater 10 via a space between the first block 100 and the intermediate block 200. Then, the first manifold 210 may be in communication with the outside via the first slot S1 formed by the first block 100 and the intermediate block 200. Therefore, the slurry accommodated in the first manifold 210 may be discharged to the outside of the slot die coater 10.

The first slot S1 may be formed between the first block 100 and the intermediate block 200. The first slot S1 may be formed by the spaced interval between the first block 100 and the intermediate block 200 and provide the passage through which the slurry may be discharged to the outside. The first slot S1 is connected to the first manifold 210 and may provide the passage through which the slurry accommodated in the first manifold 210 may be discharged to the outside.

Referring to FIG. 2, the intermediate block 200 and the second block 300 may be spaced apart at a preset interval from each other. The intermediate block 200 and the second block 300 may provide a space, through which the slurry may be moved, via the spaced interval. In other words, the intermediate block 200 and the second block 300 may form a second slot S2 with the spaced interval. The slurry may be discharged out of the slot die coater 10 via the second slot S2.

The intermediate block 200 and the second block 300 may be arranged to face each other. For example, one surface of the intermediate block 200 and one surface of the second block 300 may be arranged parallel to each other. The intermediate block 200 and the second block 300 may be arranged so that one surface of the intermediate block 200 and one surface of the second block 300 are in parallel with each other. Thus, the second slot S2 may have a constant thickness in a direction in which the slurry is discharged (X-axis direction).

The second block 300 may include the second manifold 310. The second manifold 310 may be a concave-shaped chamber formed in the second block 300. The second manifold 310 may provide a space in which the slurry supplied from the outside may be temporarily stored.

The second manifold 310 may be connected to the outside. The second manifold 310 may be in communication with the outside of the slot die coater 10 via a space between the intermediate block 200 and the second block 300. Then, the second manifold 310 may be in communication with the outside via the second slot S2 formed by the intermediate block 200 and the second block 300. Therefore, the slurry accommodated in the second manifold 310 may be discharged to the outside of the slot die coater 10.

The second slot S2 may be formed between the intermediate block 200 and the second block 300. The second slot S2 may be formed by the spaced interval between the intermediate block 200 and the second block 300 and provide the passage through which the slurry may be discharged to the outside. The second slot S2 is connected to the second manifold 310 and may provide the passage through which the slurry accommodated in the second manifold 310 may be discharged to the outside.

Referring to FIGS. 1 and 2, the second block 300, the intermediate block 200, and the first block 100 may be arranged in the direction in which the current collector moves (Z-axis direction). The second block 300, the intermediate block 200, and the first block 100 may be arranged in the stated order in a direction in which the first roller RL1 rotates.

Here, the slurry discharged from the second slot S2 is coated on the current collector CC first, and after that, the slurry discharged from the first slot S1 may be coated on the current collector CC. That is, the slurry discharged from the second slot S2 may be the lower slurry and the slurry discharged from the first slot S1 may be the upper slurry.

Referring to FIGS. 2 and 3, a first spacer 400 may be arranged between the first block 100 and the intermediate block 200. In other words, the first spacer 400 may be arranged in the first slot S1. The first spacer 400 is arranged in the first slot S1 and may be coupled to the first block 100 and the intermediate block 200.

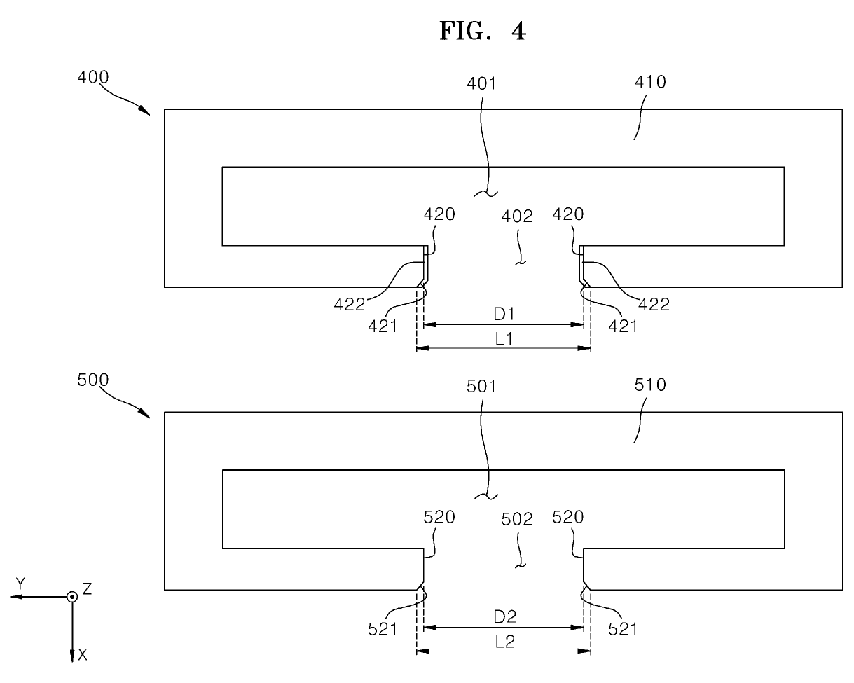

The first spacer 400 may provide the passage through which the slurry accommodated in the first manifold 210 may be discharged to the outside. The first spacer 400 may include a first body 410 (see FIG. 4), a first opening 401 formed in the first body 410 to be in communication with the first manifold 210, and a first discharge port 402 formed by opening one side of the first spacer 400 so that the first opening 401 and the outer space may be connected. That is, the slurry accommodated in the first manifold 210 may be discharged to the outside via the first opening 401 and the first discharge port 402 of the first spacer 400.

The first spacer 400 may guide the direction of discharging the slurry that is discharged through the first slot S1. The first spacer 400 may guide the direction in which the slurry accommodated in the first manifold 210 is discharged to the outside of the slot die coater 10.

For example, the first body 410 of the first spacer 400 may be arranged to be in close contact with the first block 100 and the intermediate block 200 so as to maintain the hermeticity between the first block 100 and the intermediate block 200. Thus, the first spacer 400 may guide the movement direction of the slurry so that the slurry is discharged through the first discharge port 402, when the slurry accommodated in the first manifold 210 is moved through the first slot S1.

The first discharge port 402 of the first spacer 400 may have first inner surfaces 420 forming a passage through which the slurry may be discharged. The first inner surfaces 420 of the first discharge port 402 may form the passage through which the slurry may be moved, along with surfaces of the first block 100 and the intermediate block 200.

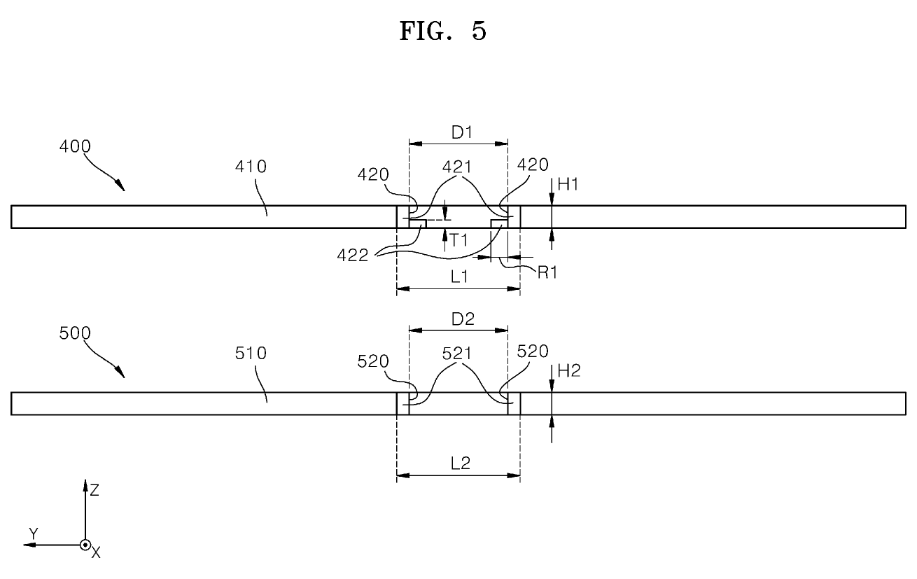

FIG. 4 is a plan view showing the first spacer and the second spacer according to an embodiment of the present disclosure. FIG. 5 is a front view of the first spacer and the second spacer of FIG. 4.

Referring to FIGS. 4 and 5, the first inner surfaces 420 of the first discharge port 402 may be arranged in a direction crossing the inner surface of the first opening 401. The first inner surfaces 420 may connect the inner circumferential surface of the first opening 401 to an outer circumferential surface of the first spacer 400, so as to fluidically connect the first opening 401 to the outer space of the first spacer 400.

Referring to FIG. 4, the first discharge port 402 of the first spacer 400 according to an embodiment of the present disclosure may have the first inner surfaces 420 arranged parallel to each other. For example, the first inner surfaces 420 of the first discharge port 402 are arranged in a direction crossing the inner circumferential surface of the first opening 401, and the respective first inner surfaces 420 may be arranged in parallel with each other.

Because the first inner surfaces 420 are arranged parallel to each other, a width of the first discharge port 402 may be constantly maintained. In other words, an amount of the slurry entering the first discharge port 402 from the first opening 401 may be equal to an amount of slurry discharged from the first discharge port 402. Thus, the slurry discharged from the first discharge port 402 may be coated on the current collector CC with a constant thickness.

In an embodiment, the first inner surfaces 420 of the first discharge port 402 according to an embodiment of the present disclosure may each have a first outer inclined surfaces 421.

Referring to FIG. 4, the first outer inclined surfaces 421 may be formed on one side of each of the first inner surfaces 420, which is opposite to the first opening 401. The first outer inclined surfaces 421 is formed on the first inner surfaces 420 and may be connected to an outer surface of the first spacer 400. Thus, the first outer inclined surfaces 421 may determine a flow state of the slurry discharged from the first discharge port 402.

The first outer inclined surfaces 421 may be inclined toward an outer side in the lengthwise direction of the first discharge port 402 (X-axis direction). That is, a first discharge width L1 through which the slurry is discharged from the first discharge port 402 may have a value different from a first inner width D1 between the first inner surfaces 420 where the first outer inclined surfaces 421 start to be formed.

For example, the first outer inclined surfaces 421 faces the outer side of the first discharge port 402 (X-axis direction) and may be inclined toward opposite to the center line of the first discharge port 402. In other words, the first discharge width L1 through which the slurry is discharged from the first discharge port 402 may have a value greater than the first inner width D1 between the first inner surfaces 420 where the first outer inclined surfaces 421 start to be formed. Thus, a pressure applied to the slurry discharged from the first discharge port 402 is reduced, and the slurry may be constantly discharged from the first discharge port 402.

Referring to FIGS. 4 and 5, the first inner surfaces 420 may each have a first protruding line 422 (e.g., a protrusion extending from the first inner surface 420 toward the first discharge port 402. The first protruding line 422 may protrude from one side of each of the first inner surfaces 420 along the lengthwise direction of the first discharge port 402.

The first protruding line 422 may adjust the flow of the slurry passing through the first discharge port 402. The first protruding line 422 may be formed to have a first protrusion height R1 (e.g., a length in the Y-axis direction) from the first inner surfaces 420, and may occupy some of the moving passage of the slurry passing through the first discharge port 402.

That is, the first protruding line 422 may interact with the slurry passing through the first discharge port 402. Thus, flow energy of the slurry passing through the first discharge port 402 from which each of the first protruding line 422 protrudes may be reduced.

In an embodiment, the first protrusion height R1 of the first protruding line 422 may be greater than a thickness of the first spacer 400. In other words, the first protrusion height R1 of the first protruding line 422 protruding from each of the first inner surfaces 420 may be greater than a first spacer thickness H1 of the first spacer 400. Thus, the first protruding line 422 may sufficiently reduce the flow energy of the slurry passing through the first discharge port 402, so that the flow rate of the slurry discharged from the first discharge port 402 may be reduced.

In another embodiment, the first protrusion height R1 of the first protruding line 422 may have a value between 1% to 3% of the first discharge width L1. When the first protrusion height R1 has a value less than 1% of the first discharge width L1, the space occupied by the first protruding line 422 in the first discharge port 402 is reduced, and thus, it may be difficult for the first protruding line 422 to affect the flow of the slurry passing through the first discharge port 402. On the contrary, when the first protrusion height R1 has a value exceeding 3% of the first discharge width L1, a ratio of the space occupied by the first protruding line 422 in the first discharge port 402 may be excessively increased and the slurry may not be sufficiently discharged.

In another embodiment, a first protrusion thickness T1 of the first protruding line 422 may be less than the first spacer thickness H1. In detail, the first protrusion thickness T1 may be less than half of the first spacer thickness H1. When the first protrusion thickness T1 is greater than half of the first spacer thickness H1, a ratio of the space occupied by the first protruding line 422 in the first discharge port 402 may be excessively increased, and the slurry may not be sufficiently discharged. Thus, the first protruding line 422 may have the first protrusion thickness T1 having a value less than half of the first spacer thickness H1 so as to appropriately adjust the flow of the slurry passing through the first discharge port 402.

The first protrusion thickness T1 and the first protrusion height R1 of the first protruding line 422 may be constantly maintained along the lengthwise direction of the first discharge port 402. That is, the influence of the first protruding line 422 on the flow of the slurry passing through the first discharge port 402 may be constantly maintained along the lengthwise direction of the first discharge port 402. Thus, the flow of the slurry discharged from the first discharge port 402 may be stably maintained.

Referring to FIG. 5, the first protruding line 422 may be arranged to be biased to one side of each of the first inner surfaces 420 in the height direction. For example, the first protruding line 422 may be formed on each of the first inner surfaces 420 to be adjacent to the intermediate block 200.

When the first protruding line 422 is formed adjacent to the intermediate block 200, the slurry passing through the first discharge port 402 may be discharged from a location spaced apart from the intermediate block 200. In other words, the first protruding line 422 may separate the position where the slurry is discharged from the first discharge port 402 and the position where the slurry is discharged from the second discharge port 502 from each other. Therefore, the upper slurry and the lower slurry may stably form a stack structure.

Referring to FIGS. 2 and 3, the second spacer 500 may be arranged between the intermediate block 200 and the second block 300. In other words, the second spacer 500 may be arranged in the second slot S2. The second spacer 500 may be arranged in the second slot S2 and may be coupled to the intermediate block 200 and the second block 300.

The second spacer 500 may provide the passage through which the slurry accommodated in the second manifold 310 may be discharged to the outside. The second spacer 500 may include a second opening 501 formed to be in communication with the second manifold 310 and a second discharge port 502 formed by opening one side of the second spacer so that the second opening 501 and the outer space may be connected. That is, the slurry accommodated in the second manifold 310 may be discharged to the outside via the second opening 501 and the second discharge port 502 of the second spacer 500.

Referring to FIGS. 2 to 5, the shape and structure of the second spacer 500 may correspond to those of the first spacer 400. For example, in a second body 510 of the second spacer 500, the second opening 501 corresponding to the first opening 401 of the first spacer 400 may be formed, and the second discharge port 502 corresponding to the first discharge port 402 of the first spacer 400 may be formed. The second opening 501 and the second discharge port 502 may provide a passage through which the slurry accommodated in the second manifold 310 is discharged via the second slot S2.

The second spacer 500 may have second inner surfaces 520 corresponding to (e.g., the same as) the first inner surfaces 420 of the first spacer 400. The second inner surfaces 520 of the second spacer 500 may guide the direction in which the slurry may be discharged from the second opening 501.

Hereinafter, descriptions about the shape and structure of the second spacer 500, which are like the corresponding structure of the first spacer 400, are omitted, and differences are described below.

The second inner surfaces 520 of the second discharge port 502 and the first inner surfaces 420 may be arranged parallel to each other. In other words, a direction in which the slurry passing through the second discharge port 502 is guided by the second inner surfaces 520 and a direction in which the slurry passing through the first discharge port 402 is guided by the first inner surfaces 420 may be parallel to each other. Thus, the slurry discharged from the first discharge port 402 may be stably coated on the lower slurry discharged from the second discharge port 502 and coated on the current collector CC.

Referring to FIGS. 4 and 5, the first discharge width L1 of the first spacer 400 and a second discharge width L2 of the second spacer 500 may have corresponding values to each other. Thus, the width of the slurry discharged from the first spacer 400 may have a value corresponding to the width of the slurry discharged from the second spacer 500.

The first inner width D1 of the first spacer 400 and a second inner width D2 of the second spacer 500 may correspond to each other. In other words, a difference (L1-D1) between the first discharge width L1 and the first inner width D1 may be equal to a difference (L2-D2) between the second discharge width L2 and the second inner width D2.

That is, the slurry passing by second outer inclined surfaces 521 in the second spacer 500 may have a flow corresponding to that of the slurry passing by the first outer inclined surfaces 421 of the first spacer 400 and may be coated on the current collector CC. Thus, the stack structure of the upper slurry and the lower slurry coated on the current collector CC may be stably formed.

Referring to FIG. 5, the first spacer thickness H1 and a second spacer thickness H2 may have corresponding values to each other. The first spacer thickness H1 and the second spacer thickness H2 have values corresponding to each other, and thus, the amount of slurry discharged from the first spacer 400 and the amount of slurry discharged from the second spacer 500 may correspond to each other.

That is, the amount of slurry discharged from the first spacer 400 and coated on the current collector CC and the amount of slurry discharged from the second spacer 500 and coated on the current collector CC may correspond to each other. Thus, the stack structure of the upper slurry and the lower slurry formed on the current collector CC may have improved structural stability.

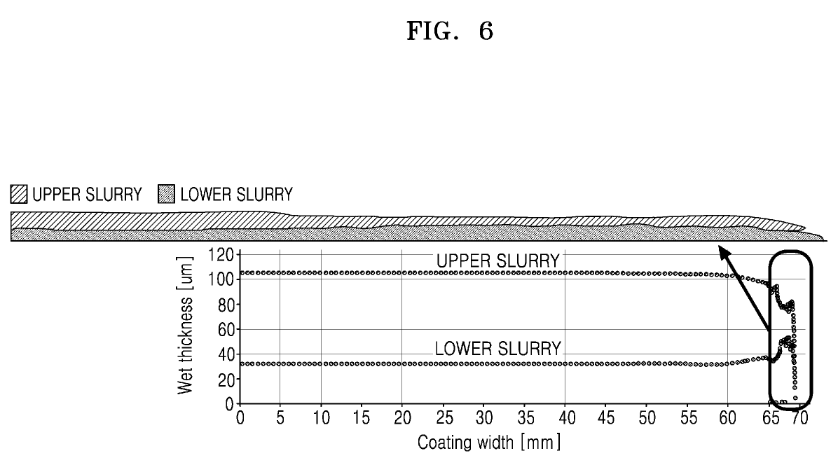

FIG. 6 is a diagram for describing a result of coating the slurry performed by the slot die coater including the first spacer and the second spacer of FIG. 4.

Referring to FIG. 6, the upper slurry and the lower slurry coated on the current collector CC by the slot die coater 10 including the first spacer 400 and the second spacer 500 according to an embodiment of the present disclosure may have stabilized stack structure.

Referring to FIGS. 4 to 6, the width of the lower slurry discharged from the second slot S2 of the slot die coater 10 and coated may have a value greater than that of the upper slurry discharged from the first slot S1 and coated. Because the width of the lower slurry coated on the current collector CC is greater than that of the upper slurry, a boundary line between the upper slurry and the lower slurry may be formed on the lower slurry.

The second spacer 500 is arranged in the second slot S2, and thus, the lower slurry may be coated on the current collector CC via the second discharge port 502. Also, the first spacer 400 is arranged in the first slot S1 so that the upper slurry may be coated on the lower slurry via the first discharge port 402.

The first inner surfaces 420 of the first discharge port 402 have the first discharge width L1 that is equal to the second discharge width L2 of the second inner surfaces 520, and the width of the upper slurry that is coated after each of the first protruding line 422 are formed may be less than that of the lower slurry. In other words, each of the first protruding line 422 formed on the first inner surfaces 420 may adjust the flow of the slurry passing through the first discharge port 402 so that the width of the slurry discharged through the first discharge port 402 may be reduced.

The upper slurry may be arranged on the lower slurry so that the bonding between the upper slurry and the lower slurry may be firm. The boundary between the upper slurry and the lower slurry is formed on the lower slurry so that a contact area between the upper slurry and the lower slurry may be maximized. Thus, the stack structure of the upper slurry and the lower slurry formed on the current collector CC may have improved structural stability.

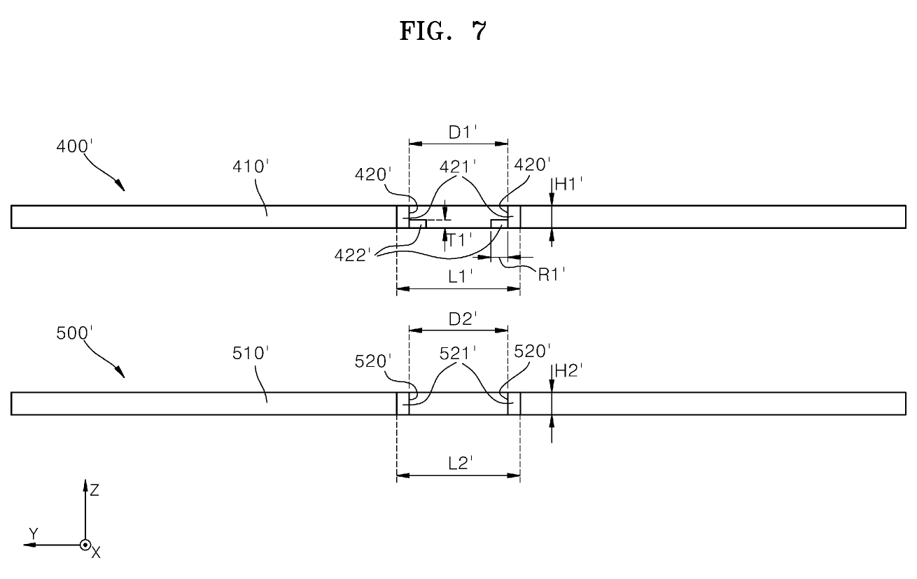

FIG. 7 is a front view showing a first spacer and a second spacer according to another embodiment of the present disclosure.

A first spacer 400' and a second spacer 500' according to another embodiment of the present disclosure only differ from the first spacer 400 and the second spacer 500 described above with reference to the previous embodiment in view of detailed sizes of respective components, and thus, redundant descriptions are omitted and differences are described below.

Referring to FIG. 7, a second discharge width L2' between second inner surfaces 520' provided in the second spacer 500' may have a value greater than a first discharge width L1' between first inner surfaces 420' provided in the first spacer 400'. In other words, a width of the slurry discharged through the second spacer 500' may be greater than a width of the slurry discharged through the first spacer 400'.

Thus, the width of the lower slurry coated on the current collector CC after passing through the second inner surfaces 520' may be greater than the width of the upper slurry coated on the lower slurry after passing through the first inner surfaces 420'.

A second inner width D2' between the second inner surfaces 520' may be greater than the first inner width D1' between the first inner surfaces 420'. In other words, the slurry passing between the second inner surfaces 520' may have a greater width than the slurry passing between the first inner surfaces 420'.

In an embodiment, a difference (L1'-D1') between the first discharge width L1' and the first inner width D1' may be equal to a difference (L2'-D2') between the second discharge width L2' and the second inner width D2'. That is, the slurry passing by second outer inclined surfaces 521' in the second spacer 500' may have a flow corresponding to that of the slurry passing by the first outer inclined surfaces 421' of the first spacer 400' and may be coated on the current collector CC. Thus, the stack structure of the upper slurry and the lower slurry coated on the current collector CC may be stably formed.

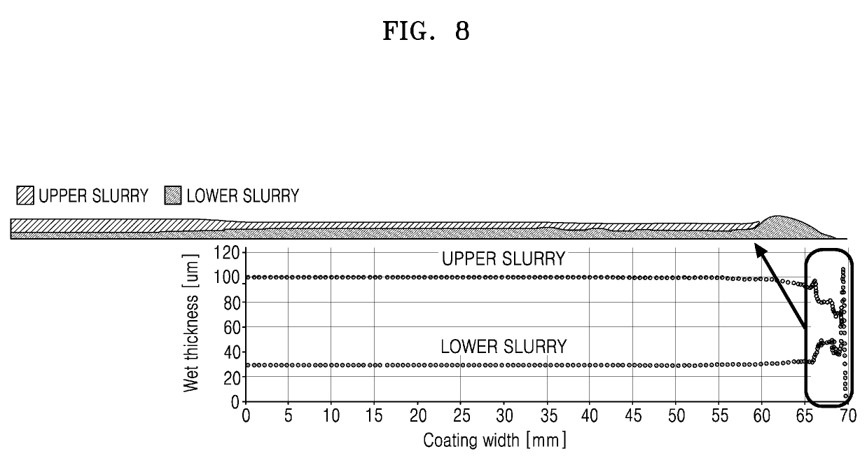

FIG. 8 is a diagram for describing a result of coating slurry performed by the slot die coater including the first spacer and the second spacer of FIG. 7.

Referring to FIG. 7, the upper slurry and the lower slurry coated on the current collector CC by the slot die coater 10' including the first spacer 400' and the second spacer 500' according to another embodiment of the present disclosure may have stabilized stack structure.

Referring to FIGS. 6 and 7, the width of the lower slurry discharged from the second slot S2' of the slot die coater 10' and coated may have a value greater than that of the upper slurry discharged from the first slot S1' and coated. Because the width of the lower slurry coated on the current collector CC is greater than that of the upper slurry, a boundary line between the upper slurry and the lower slurry may be formed on the lower slurry.

The second spacer 500' is arranged in the second slot S2', and thus, the lower slurry may be coated on the current collector CC via the second discharge port 502'. Also, the first spacer 400' is arranged in the first slot S1' so that the upper slurry may be coated on the lower slurry via the first discharge port 402'.

The first inner surfaces 420' of the first discharge port 402' have a first discharge width L1' having a less value than a second discharge width L2' between the second inner surfaces 520', and thus, the width of the upper slurry may be less than the width of the lower slurry. In other words, the slurry passing between the first inner surfaces 420' may have a greater width than the slurry passing between the second inner surfaces 520' and may be coated on the current collector CC.

First protruding lines 422' are formed on the first inner surfaces 420' of the first discharge port 402', respectively, and thus, the width of the upper slurry may be less than that of the lower slurry. The flow of the slurry passing between the first inner surfaces 420' is adjusted by the first protruding lines 422', and thus, the width of the slurry coated on the current collector CC may be reduced.

Thus, the width of the lower slurry having passed between the second inner surfaces 520' and coated on the current collector CC may be less than that of the upper slurry having passed between the first inner surfaces 420' and coated on the current collector CC.

The upper slurry may be arranged on the lower slurry so that the bonding between the upper slurry and the lower slurry may be firm. The boundary between the upper slurry and the lower slurry is formed on the lower slurry so that a contact area between the upper slurry and the lower slurry may be maximized, and the stack structure of the slurry and the current collector CC may be stably formed.

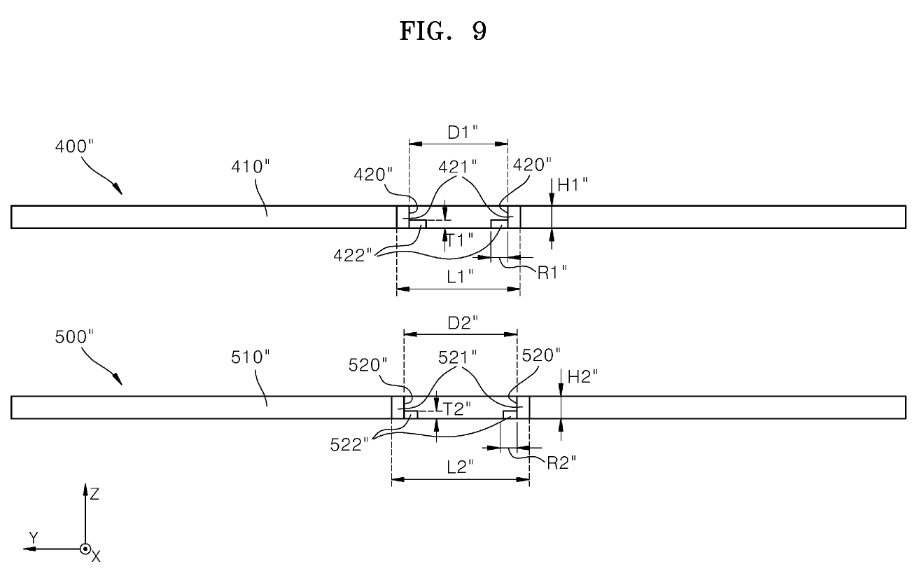

FIG. 9 is a front view showing a first spacer and a second spacer according to another embodiment of the present disclosure.

A first spacer 400" and a second spacer 500" according to another embodiment of the present disclosure are different from the first spacer 400 and the second spacer 500 according to the embodiment of the present disclosure only in view of a detailed structure and shape of the second spacer 500", and thus, redundant descriptions are omitted and differences are described below.

Referring to FIG. 9, second protruding lines 522” may be formed on second inner surfaces 520" of the second spacer 500". The second protruding lines 522” may be formed protruding from one side of each of the second inner surfaces 520" along the lengthwise direction of the second discharge port 502".

The second protruding lines 522” may adjust the flow of the slurry passing through the second discharge port 502". The second protruding lines 522” may be formed to have a first protrusion height R1" from the second inner surfaces 520", and may occupy some of the moving passage (e.g., may occupy some of the space that would be occupied by the slurry were the second protruding lines 522’’ not present) of the slurry passing through the second discharge port 502".

The second protruding lines 522” may interact with the slurry passing through the second discharge port 502". Thus, flow energy of the slurry passing through the second discharge port 502" in which the second protruding lines 522” are formed may be reduced.

Referring to FIG. 9, a second protrusion height R2" of the second protruding lines 522” may be less than the second protrusion height R2" of the first protruding lines 422". Because the second protrusion height R2" has a value less than the first protrusion height R1", influence of the second protruding lines 522” on the flow of slurry passing through the second discharge port 502" may be less than the influence of the first protruding lines 422" on the flow of slurry passing through the first discharge port 402".

That is, the width of the lower slurry having passed through the second discharge port 502" and coated on the current collector CC may have a value less than the width of the upper slurry having passed through the first discharge port 402" and coated on the current collector CC.

Referring to FIG. 9, a second protrusion thickness T2" of each of the second protruding lines 522” may be less than a first protrusion thickness T1" of each of the first protruding lines 422". Because the second protrusion thickness T2" has a value less than the first protrusion thickness T1", the influence of the second protruding lines 522” on the flow of slurry passing through the second discharge port 502" may be less than the influence of the first protruding lines 422" on the flow of slurry passing through the first discharge port 402".

Thus, the width of the lower slurry discharged from the second discharge port 502" and coated on the current collector CC may have a value less than the width of the upper slurry discharged from the first discharge port 402" and coated on the current collector CC.

In an embodiment, a first discharge width L1" between the first inner surfaces 420" and a second discharge width L2" between the second inner surfaces 520" may have corresponding values to each other (e.g., may be the same). Thus, the width of the slurry discharged from the first spacer 400" may correspond to the width of the slurry discharged from the second spacer 500".

In another embodiment, a second discharge width L2'' between second inner surfaces 520'' provided in the second spacer 500'' may have a value greater than a first discharge width L1'' between first inner surfaces 420'' provided in the first spacer 400''. Thus, the width of the lower slurry coated on the current collector CC after passing through the second inner surfaces 520'' may be greater than the width of the upper slurry coated on the lower slurry after passing through the first inner surfaces 420''.

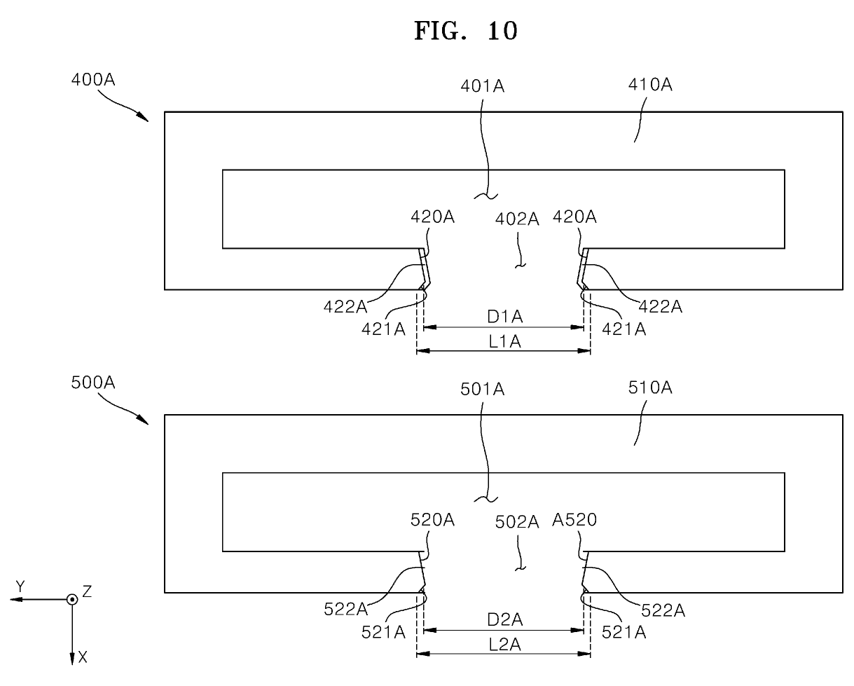

FIG. 10 is a plan view showing a first spacer and a second spacer according to another embodiment of the present disclosure.

When comparing a first spacer 400A and a second spacer 500A according to another embodiment of the present disclosure with the first spacer 400 and the second spacer 500 according to the previous embodiment, there is only a difference in a detailed shape of a first inner surfaces 420A and a second inner surfaces 520A, and thus, differences are described below.

Referring to FIG. 10, a width between the first inner surfaces 420A provided in the first spacer 400A may be reduced outward along the lengthwise direction of a first discharge port 402A. The first inner surfaces 420A may be arranged to be inclined toward a first opening 401A. That is, the width between the first inner surfaces 420A provided in the first spacer 400A may be reduced toward a direction opposite to the first opening 401A (X-axis direction) along the lengthwise direction of the first discharge port 402A.

Because the width between the first inner surfaces 420A is reduced outward along the lengthwise direction of the first discharge port 402A, the slurry passing through the first discharge port 402A may be pressed by the first inner surfaces 420A. Thus, the slurry coated on the current collector CC via the first discharge port 402A may be concentrated on the center of the current collector CC.

The first inner surfaces 420A have the width reduced along the lengthwise direction of the first discharge port 402A and then increased again on one side (e.g., an outer side). For example, the first inner surfaces 420A may have first outer inclined surfaces 421A formed on one side opposite to the first opening 401A.

The first outer inclined surfaces 421A may face the outer side of the first discharge port 402A (X-axis direction), and may have an inclination toward the direction opposite to the center line of the first discharge port 402A. That is, the width between the first inner surfaces 420A is reduced along the lengthwise direction of the first discharge port 402A, and then, may be increased at the portion where the first outer inclined surfaces 421A are formed.

The first outer inclined surfaces 421A may determine a flow state of the slurry discharged from the first discharge port 402A. The first outer inclined surfaces 421A may have an inclination toward the direction opposite to the center line of the first discharge port 402A, and thus, the pressure applied to the slurry discharged from the first discharge port 402A may be reduced at the portion where the first outer inclined surfaces 421A is formed. Thus, the slurry may be uniformly discharged from the first discharge port 402A.

First protruding lines 422A may be formed protruding from the first inner surfaces 420A provided in the first spacer 400A. The first protruding lines 422A may extend along the first inner surfaces 420A having the inclination with respect to the lengthwise direction of the first discharge port 402A (X-axis direction). Thus, the influence of the first protruding lines 422A on the slurry passing through the first discharge port 402A may be constantly maintained in the lengthwise direction of the first discharge port 402A.

The second spacer 500A may have a shape and structure corresponding to (e.g., the same as) the first spacer 400A. For example, the second spacer 500A may have second inner surfaces 520A corresponding to the first inner surfaces 420A of the first spacer 400A. Also, the second spacer 500A may have second outer inclined surfaces 521A corresponding to the first outer inclined surfaces 421A of the first spacer 400A.

A first discharge width L1A of the first spacer 400A and a second discharge width L2A of the second spacer 500A may have corresponding values to each other. Also, a first inner width D1A of the first spacer 400A and a second inner width D2A of the second spacer 500A may have corresponding values to each other. Thus, the flow state of the slurry passing through the first discharge port 402A may correspond to that of the slurry passing through the second discharge port 502A.

The first protruding lines 422A may be formed on the first inner surfaces 420A, respectively, of the first spacer 400A. The first protruding lines 422A may interact with the slurry passing through the first discharge port 402A to adjust the flow state of the slurry.

That is, the width of the slurry discharged from the first discharge port 402A and coated on the lower slurry may have a value less than the width of the slurry discharged from the second discharge port 502A and coated on the current collector CC. Therefore, the bonding between the slurry and the current collector CC may be firmly maintained.

In order to get uniform charging/discharging characteristics of a secondary battery, it is best to evenly coat the positive electrode active material slurry and the negative electrode active material slurry on the current collector.

The slot die coater and the slurry coating apparatus including the same according to the embodiments of the present disclosure may adjust the width of the slurry coated on the current collector, and thus, the structural stability of the slurry coated on the current collector may be improved. Specifically, in the slot die coater and the slurry coating apparatus including the same according to the embodiments of the present disclosure, the shapes and structures of the first spacer and the second spacer may be set differently so that the upper slurry may have a width less than that of the lower slurry. The boundary between the upper slurry and the lower slurry may be arranged on the lower slurry so that the bonding among the upper slurry, the lower slurry, and the current collector may be firmly maintained.

The slot die coater and the slurry coating apparatus including the same according to the embodiments of the present disclosure may adjust the width of the slurry coated on the current collector, and thus, the structural stability of the slurry coated on the current collector may be improved.

Effects obtainable from the present disclosure may be non-limited by the above-mentioned effect. Other unmentioned effects may be clearly understood from the following description by one of ordinary skill in the art to which the present disclosure pertains.

Therefore, the spirit of the present disclosure shall not be limited to the above-described embodiments, and the entire scope of the appended claims and their equivalents will fall within the scope and spirit of the disclosure.

The present disclosure has been described in detail. However, it should be understood that the detailed description and specific examples, while indicating preferred embodiments of the disclosure, are given by way of illustration only, since various changes and modifications within the spirit and scope of the disclosure will become apparent to one of ordinary skill in the art from this detailed description.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A slot die coater, comprising:
an intermediate block;
a first block facing one side of the intermediate block;
a second block facing an opposite side of the intermediate block;
a first spacer between the first block and the intermediate block, the first spacer having a first discharge port; and
a second spacer between the second block and the intermediate block, the second spacer having a second discharge port,
wherein a pair of first inner surfaces on opposite sides of the first discharge port, respectively, have first protruding lines extending along a lengthwise direction of the first discharge port, each of the first protruding lines having a first height.

2. The slot die coater as claimed in claim 1, wherein the pair of first inner surfaces are parallel to each other.

3. The slot die coater as claimed in claim 1, wherein a width of the first discharge port is reduced outward in the lengthwise direction of the first discharge port.

4. The slot die coater as claimed in claim 1, wherein each of the pair of first inner surfaces has a first outer inclined surface being inclined outward in the lengthwise direction of the first discharge port.

5. The slot die coater as claimed in claim 1, wherein the pair of first inner surfaces and a pair of second inner surfaces in the second discharge port are parallel to each other.

6. The slot die coater as claimed in claim 1, wherein the first protruding lines are on the pair of first inner surfaces of the first discharge port and adjacent to the intermediate block.

7. The slot die coater as claimed in claim 1, wherein the first protruding lines each have a first protrusion height smaller than a thickness value of the first spacer.

8. The slot die coater as claimed in claim 1, wherein a first discharge width of the first discharge port is less than or equal to a second discharge width of the second discharge port.

9. The slot die coater as claimed in claim 1, wherein second protruding lines each having a second height are on second inner surfaces of the second discharge port along a lengthwise direction of the second discharge port.

10. The slot die coater as claimed in claim 9, wherein a second protrusion height of the second protruding lines is less than a first protrusion height of the first protruding lines.

11. A slurry coating apparatus, comprising:
a slurry tank accommodating slurry;
a roller unit transporting a current collector on which the slurry is coated; and
a slot die coater receiving a supply of slurry from the slurry tank and coating the current collector with the slurry, wherein:
the slot die coater comprises: an intermediate block; a first block facing the intermediate block on one side of the intermediate block; a second block facing the intermediate block on an opposite side of the intermediate block; a first spacer between the first block and the intermediate block, the first spacer having a first discharge port; and a second spacer between the second block and the intermediate block, the second spacer having a second discharge port, and
a pair of first inner surfaces on opposite sides of the first discharge port, respectively, have first protruding lines, each of the first protruding lines having a first length in a lengthwise direction of the first discharge port.

12. The slurry coating apparatus as claimed in claim 11, wherein the second block, the intermediate block, and the first block are in a direction in which the current collector moves.

13. The slurry coating apparatus as claimed in claim 11, wherein the pair of first inner surfaces are parallel to each other.

14. The slurry coating apparatus as claimed in claim 11, wherein a width of the first discharge port is reduced outward in the lengthwise direction of the first discharge port.

15. The slurry coating apparatus as claimed in claim 11, wherein each of the pair of first inner surfaces has first outer inclined surface having a width increased outward in the lengthwise direction of the first discharge port.

16. The slurry coating apparatus as claimed in claim 11, wherein each of the pair of first inner surfaces and a pair of second inner surfaces in the second discharge port are parallel to each other.

17. The slurry coating apparatus as claimed in claim 11, wherein the first protruding lines are on the first inner surfaces of the first discharge port, to be adjacent to the second block.

18. The slurry coating apparatus as claimed in claim 11, wherein the first protruding lines each have a first length value greater than a thickness of the first spacer.

19. The slurry coating apparatus as claimed in claim 11, wherein a first discharge width of the first discharge port is less than or equal to a second discharge width of the second discharge port.

20. The slurry coating apparatus as claimed in claim 11, wherein second protruding lines each having a second height are on second inner surfaces of the second discharge port along a lengthwise direction of the second discharge port.
